(19) United States
(12) Patent Application Publication
(10) Pub. No.: US 2023/0340819 A1
(43) Pub. Date: Oct. 26, 2023

(54) HIGH-CAPACITY MULTI-BAR LINKAGE HINGE ASSEMBLY FOR PIVOTALLY MOUNTED WINDOW VENT

(71) Applicant: CALDWELL MANUFACTURING COMPANY NORTH AMERICA, LLC, Rochester, NY (US)

(72) Inventors: Nathan C. SERFASS, Rochester, NY (US); James M. MCINNIS, Hilton, NY (US); Patrick E. MILLIGAN, Rochester, NY (US); Matthew N. BRADY, Spencerport, NY (US)

(73) Assignee: CALDWELL MANUFACTURING COMPANY NORTH AMERICA, LLC, Rochester, NY (US)

(21) Appl. No.: 18/008,508

(22) PCT Filed: Jun. 4, 2021
(86) PCT No.: PCT/US2021/035862

§ 371 Date: Dec. 6, 2022

Related U.S. Application Data
(60) Provisional application No. 63/038,979, filed on Jun. 15, 2020.

(51) Int. Cl. E06B 3/38; E05D 15/44

(52) U.S. Cl. CPC E05D 15/44; E06B 3/38; E05Y 2900/148

(57) ABSTRACT

A multi-bar linkage assembly for a pivotally mounted window sash and, more particularly, a high-capacity hinge assembly is disclosed. The hinge assembly is less susceptible to deflection during operation and may be used with and support window vents more than 100 in. tall and weighing more than 400 lbs. Notwithstanding the hinge assembly’s wide range of use, the hinge assembly stack height does not exceed the industry standard of 0.625 in. for conventional hinge assemblies incapable of use in heavy-duty applications. The hinge assembly may be used with standard form window frames without requiring redesigning or otherwise modifying the window frame’s standard form cross-section.

### CROSS-REFERENCE TO RELATED APPLICATIONS

This Application claims the benefit of U.S. Provisional Application 63/038,979 filed on Jun. 15, 2020. The entire disclosure of the above application is incorporated herein by reference.

### FIELD

The present disclosure relates generally to multi-bar linkage assemblies for pivotally mounted window sashes (i.e., friction supporting vent window stays) and, more particularly, to a high-capacity window sash friction supporting stay

### BACKGROUND

This section provides background information related to the present disclosure which is not necessarily prior art.

Multi-bar linkage hinge assemblies (also known as “friction stays”) may be employed in awning or projection-type window assemblies and casement-type window assemblies, for example. Such hinge assemblies may allow pivotal movement of a window vent or sash relative to a window frame such that the window vent is off-center from the hinge assembly in a direction toward the exterior of the window.

In projection-type window assemblies, first and second hinge assemblies may be attached to respective first and second opposed vertically extending sides of the window sash and may be mounted to the window assembly at the opposed vertical sides of the window frame. As such, the hinge assemblies are disposed between the window frame and the opposed lateral sides of the window vent.

The fenestration industry has developed and adopted conventions for standard form window frame cross-sections (e.g., the window frame extrusion) and dimensions which, in turn, have defined a predetermined space (or “operating envelope”) in which hinge assemblies for vent windows must operably fit without necessitating a modification or redesign of the standard form construction. Currently, the size and weight limits (e.g., about 300 lbs.) of conventional hinge assemblies for projection-type window assemblies which satisfy the operating envelope are unsuitable to accommodate heavy-duty and/or commercial-grade window vents.

It, therefore, would be advantageous to provide a hinge assembly for projection-type window that meets the operating envelope for standard form window frames constructions without redesign or modification and is further operable with heavy-duty and/or commercial-grade window vents in excess of about 300 lbs.

### SUMMARY

This section provides a general summary of the disclosure, and is not a comprehensive disclosure of its full scope or all of its features.

The present disclosure provides a high capacity, multi-bar linkage assembly for a pivotally mounted window sash, the linkage assembly movable between a closed position and an opened position. The linkage assembly includes a track configured for attachment to a window frame having a channel, a first end portion and a second end portion, a slider assembly slidable within the channel of the track, a vent bar having a central longitudinal axis and extending from a first end portion to a second end portion and configured for attachment to a window sash, and an intermediate linkage assembly connecting the vent bar to both the track and the slider assembly. The intermediate linkage assembly has a connector link or first intermediate link, a brace or second intermediate link and a strut or fourth intermediate link a having a central longitudinal axis and extending along from a first end portion to a second end portion. Optionally, the intermediate linkage assembly can include a third intermediate link.

The connector pivotally connects to the first end portion of the vent bar and pivotally connects to a first end portion of the slider assembly. A first end portion of the brace pivotally connects to a second end portion of the slider assembly and a second end portion of the brace pivotally connects to the strut at a first pivotal connection that is laterally offset from the central longitudinal axis of the strut. The strut further pivotally connects to the track and the vent bar, the first end portion of the strut pivotally connected to a second end portion of the track and the second end portion of the strut pivotally connected to the vent bar at a second pivotal connection that is laterally offset from the central longitudinal axis of the vent bar.

The second end portion of the strut can include a recess portion and the first pivotal connection and the second pivotal connection can be located in the recess portion.

In other aspects of the disclosure, the fourth intermediate link can be a bar having a first thickness and the second intermediate link cab be a bar having a second thickness. The first thickness can be about two times greater than the second thickness. The recess portion can have a depth substantially equal to the second thickness. Further, the recess portion can have a surface that is bounded on at least one side by a side wall extending from the surface. The side wall can extend from the surface a distance, e.g., as much as the second thickness. The second intermediate link can be configured to abut the wall when the multi-bar linkage assembly is in the closed position.

In other aspects of the disclosed linkage assembly, the recess portion can be configured to receive the second end portion of the second intermediate link such that a surface on a first side of the second intermediate link is generally coplanar with a surface on a first side of the fourth intermediate link. Still further, the second intermediate link can be connected to the fourth intermediate link at a first side of the fourth intermediate link and the vent bar can be connected to the fourth intermediate link at a second side of the fourth intermediate link opposite to the first side.

The hinge assembly of the present disclosure provides a stronger, more robust and rigid hinge assembly less susceptible to deflection or deformation during operation as compared with prior known hinge assemblies which enables the hinge assembly to be used with and support a wider range of sizes and weights of window vents (e.g., as tall as about 110 in. or more and/or weighing as much as about 450 lbs. or more). Moreover, the hinge assembly can have a stack height (Hs) of 0.625 in. notwithstanding that the hinge assembly can be used in heavy-duty applications in applications. Further, the overall cross-sectional space claim or “envelope” of the hinge assembly preferably does not exceed 0.625 in. x 1.015 in. These features advantageously enable the hinge assembly of the present disclosure to be used in existing standard form window frames without redesign or modification.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a front view of a hinge assembly according to the principles of the present disclosure in an opened (expanded) position and as installed in a window assembly which is shown schematically;

FIG. 2 is a front view of the hinge assembly of FIG. 1 shown in a closed (collapsed) position;

FIG. 3 is a partial cross-sectional view taken along the line 3-3 of FIG. 2;

FIG. 4 is a right side view of the hinge assembly shown in FIG. 2;

FIG. 5 is an exploded perspective view of the hinge assembly of the present disclosure;

FIG. 5A is an enlarged detail view of a portion of FIG. 5;

FIG. 6 is a partial perspective view of a portion of a hinge assembly according to the present disclosure;

FIG. 7 is an enlarged partial plan view of a portion of a hinge assembly according to the present disclosure;

FIGS. 7A and 7B show, respectively, enlarged partial plan views of portions of alternative embodiments of the hinge assembly according to the present disclosure; and

FIG. 8 shows and enlarged, partial, exploded perspective view of a portion of an alternative embodiment of the hinge assembly according to the present disclosure.

Corresponding reference numerals indicate corresponding parts throughout the several views of the drawings.

### DETAILED DESCRIPTION

Example embodiments will now be described more fully with reference to the accompanying drawings.

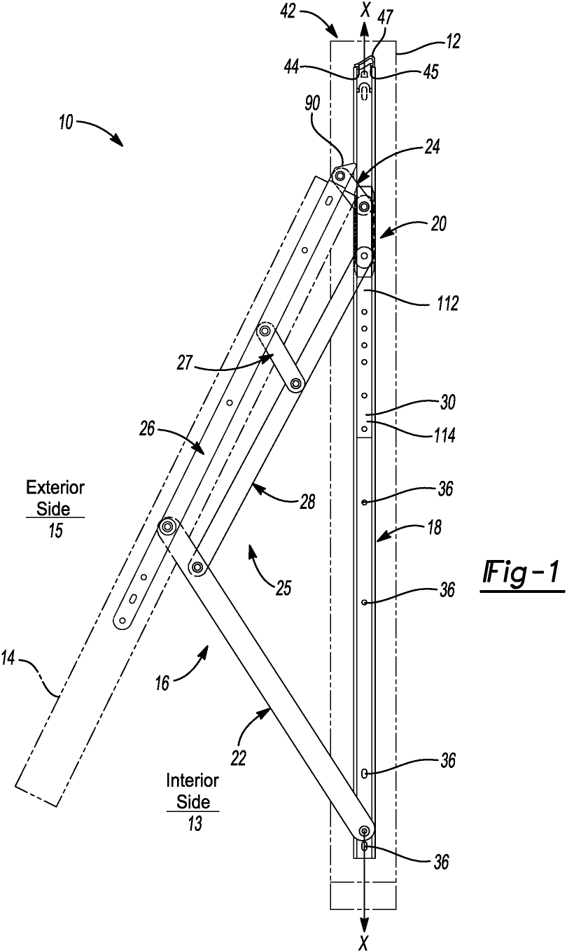

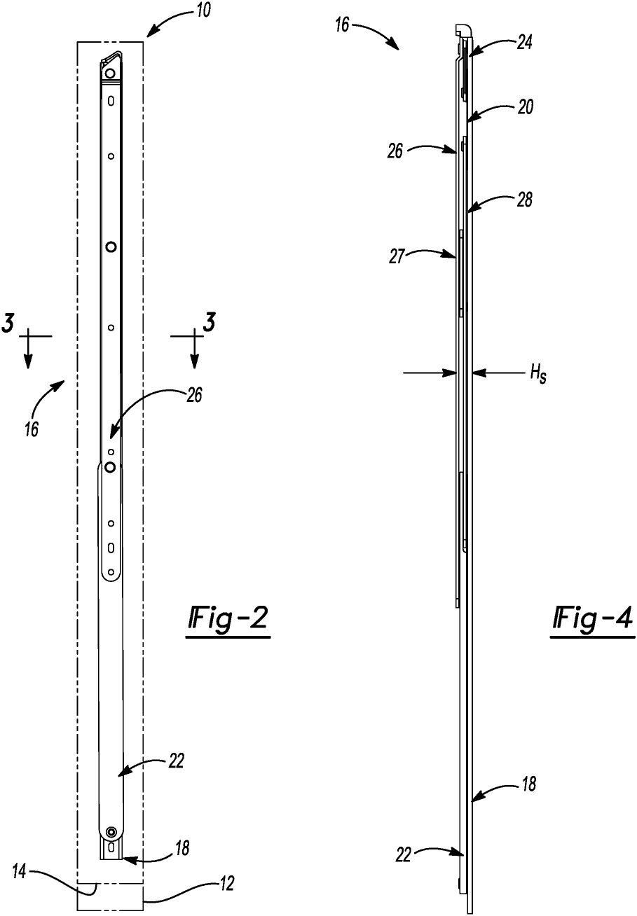

With reference to FIGS. 1 and 2, a window assembly 10 is provided that may include a window frame 12, a window vent or sash 14 having an interior side and an exterior side, and a pair of multi-bar linkage hinge assemblies 16 (only one being shown in FIG. 1). The hinge assemblies 16 may be expanded and collapsed to correspondingly move the window sash 14 relative to the window frame 12 between a vent opened position (FIG. 1) and a vent closed position (FIG. 2). The window assembly 10 shown in FIG. 1 is an awning-type window assembly. Therefore, the hinge assemblies 16 may be disposed on opposed horizontal (lateral) sides of the window assembly 10 between the window frame 12 and window vent 14. However, it will be appreciated that the hinge assemblies 16 could be incorporated into other types of window assemblies, such as a casement-type window assembly where the hinge assemblies 16 may be disposed on one or both opposed vertical sides of the window assembly 10 between the window frame 12 and window vent 14, for example.

Referring now to FIGS. 1-5, each of the hinge assemblies 16 may be a multi-bar linkage and may include a track 18, a slider assembly or shoe assembly 20, a vent bar 26, an intermediate linkage assembly 25 connecting the track and slider assembly 20 to the vent bar 26 and a stop member or limit stop 30. The intermediate linkage assembly 25 may include a connector link or upper shoe link 24, a brace or lower shoe link 28, a strut 22 and, optionally, a crosslink 27.

Each of the hinge assemblies 16 may be movable between an opened position (FIG. 1) and a closed position (FIG. 2). Also, as further described, the stop member 30 may serve to limit a range of motion of the hinge assembly 16 (i.e., via the slider assembly 20 relative to the track 18) thereby limiting an angle to which the window sash 14 can be opened relative to the window frame 12 (i.e., limiting a range of motion of the window sash 14 relative to the window frame 12).

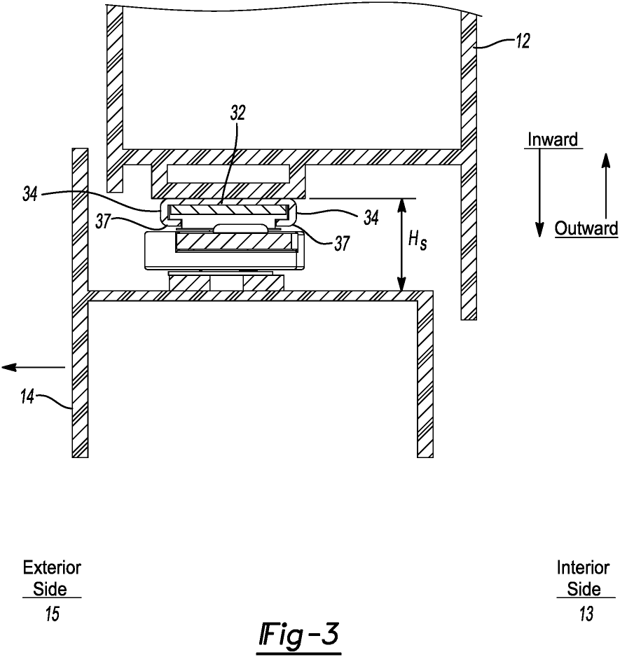

The track 18 may include an elongate body 32 extending along a central longitudinal axis X from a first or upper vertical end 38 to a second or lower vertical end 40. As best seen in FIG. 3, two opposed and parallel side walls 34 may extend from opposite lateral sides of the body 32. At its distal end, each side wall 34 may include a flange 37 that extends generally perpendicularly inwardly and toward the opposing side wall 34. As such, interior surfaces of the body 32, side walls 34 and flange 37, then, may cooperate to form a shallow, generally C-shaped channel 35. When the hinge assembly 16 is installed in a window assembly 10, the C-shaped channel 35 of the track 18 faces inwardly or in an inboard direction (i.e., from the window frame 12 and toward the window vent 14). The inwardly facing end of the channel 35 defines an inner planar boundary of the track 18.

The slider assembly 20 and the stop member 30 may each be received in the channel 35 and may each be laterally captured in the channel 35 by the side walls 34 and flanges 37. Notwithstanding, though, both the slider assembly 20 and the stop member 30 remain able to move and/or be positioned along the track 18 in the direction of the longitudinal axis X.

A plurality of first apertures and/or first slots 36 may extend through the body 32 of the track 18. Fasteners (e.g., screws), then, may extend through the apertures 36 of the body 32 to fixedly secure the track 18 to the window frame 12.

The track 18 may also include an end cap 42 at the first end 38 of the elongate body 32. The end cap 42 may engage and be affixed to the first end 38 of the body 32. The end cap 42 may include a front internal camming surface 44 and a rear internal wall 45. The camming surface 44 and the internal wall 45 intersect at an apex 47 that is laterally offset from the longitudinal axis X of the body 32 of the track 18 toward the rear internal wall 45. The rear internal wall 45 extends generally parallel to the longitudinal axis X and the camming surface 44 is inclined relative to the longitudinal axis X so as to intersect the rear internal wall 45 and form the apex 47.

The camming surface 44 is configured to engage an upper end 90 of the vent bar 26 when the hinge assembly 16 is near and/or in the closed position. As the bar 24 moves to the closed position, the inclined surface 40 on the upper end portion of the vent bar engages the inclined camming surface 44 on the end cap 42 with a wedging action, bringing the upper end 90 into abutting engagement with the end cap 42. It may be appreciated that engagement between the upper end 90 of the vent bar 26 and the camming surface 44 on the end cap 42 prevents the hinge assembly 16 being opened without a force sufficient to overcome the wedging action.

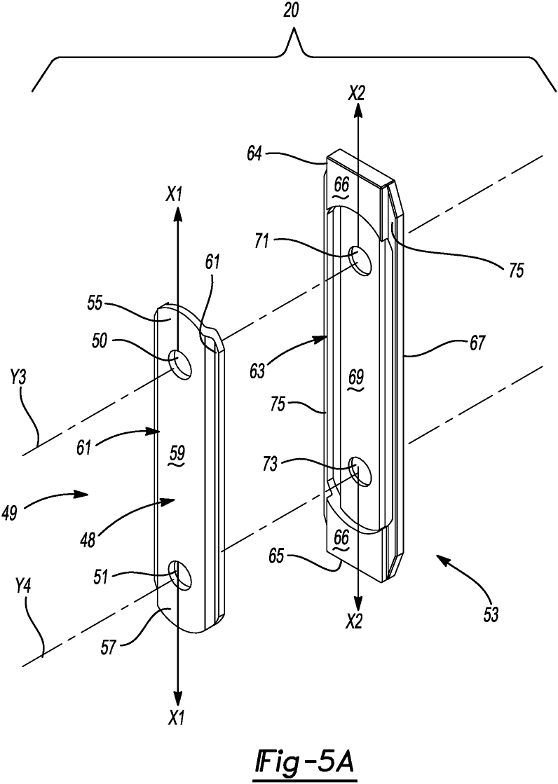

The shoe or slider assembly 20 included in the hinge assembly 16 may engage the track 18 and may be disposed and slidable within the channel 35 along the direction of the longitudinal axis X. The slider assembly 20 may comprise a two-component assembly and include a shoe link 49 and a slider pad 53, each made from dissimilar materials. The shoe link 49 may be an elongate, linear, bar-like metal body 48 extending for a length along a central longitudinal axis X1 from a first end 55 to a second 57. The body 48 may include a first aperture 50 and a second aperture 51 extending through the body 48 (FIG. 5A), one each of the apertures 50, 51 located near a respective opposite longitudinal end 55, 57 of the shoe link 49 and centered on the axis X1. The shoe link 49 may have a raised or embossed central portion defining an upper surface 59 of the shoe link 49. The upper surface 59 of the shoe link 49 may be flanked by opposed lateral side edges 61 in the form of stepped-down flanges which extend the length of the body 48 of the shoe link 49. The shoe link 49 may be received in or accommodated by the slider pad 53.

The slider pad 53 may be an elongate plastic body 63 extending for a length along a central longitudinal axis X2 from a first end 64 to a second end 65. The slider pad 53 may have an upper surface 66, a lower surface 67 and a central recess portion 69 in which the shoe link 49 may be received or accommodated to form the slider assembly 20. The recess portion 69 of body 63 of the slider pad 53 may also include a first aperture 71 and a second aperture 73 extending through the body 63 of the slider pad 53, one each near an opposed longitudinal end 64, 65 of the body 63. At the opposite lateral sides of the body 63 of the slider pad 53, the slider pad 53 may also include opposed lateral side edges 75, portions of which are in the form of stepped-down flanges. The recess portion 69 provides a void that is sized and shaped to complement the geometry of the shoe link 49. The shoe link 49 may snugly set into or nest with the slider pad 53 such that the longitudinal axes X1 and X2 are coincident and at least a portion of the perimeter of the shoe link 49 may be surrounded by the slider pad 53, as understood with reference to FIG. 5A.

Additionally, when the shoe link 49 is received in the recess portion 69 of the slider pad 53, the first and second apertures 71, 73 in the slider pad 53 align with the first and second apertures 50, 51 in the shoe link 49 (e.g., the apertures 50, 71 and 51, 73 may be generally coaxial). A fastener (e.g., a rivet) may then be used to affix the shoe link 49 with the slider pad 53, as further described herein. Moreover, in the slider assembly 20, the respective upper surfaces 59, 66 of the shoe link 49 and the slider pad 53 are substantially flush with one another. Still further, the surfaces of the respective lateral side edges 61, 75 of the shoe link 49 and slider pad 53, including the stepped-down flanges, are likewise substantially flush.

The slider assembly 20 may be dimensioned to fit within and be retained by the channel 35 of the track 18. The lateral side edges 61, 75 of the slider assembly 20 may be captured by the channel 35 and the lower surface 67 and lateral edges 61, 75 of the slider assembly 20 may directly engage the channel 35. The upper surface 59, 66 of the slider assembly 20 may be substantially flush with or extend slightly beyond the inner planar boundary of the track 18 (i.e., defined by the top surfaces 54 of the side flanges 37, as best seen in FIG. 3). The slider assembly 20 slides smoothly and durably within the channel 35 of the track 18.

The shoe link 49 may be formed from stainless steel or brass, for example. The slider pad 53 may be formed from nylon, for example. The slider pad 53, and especially the lower surface 67 and lateral edges 75 of the slider pad body 53, may be made from, for example, a durable polymer material having a known coefficient of friction. In this manner, the slider pad 53 may produce a predetermined or desired amount of sliding friction (i.e., a friction force) between the lower surface 67 of the slider pad body 53 and the channel 35 of the track 18. It will be appreciated, however, that the slider assembly 20 components could be formed from other suitable metallic, polymeric or composite materials, for example.

The stop member 30 may be received in the channel 35 of the track 18 in between the slider assembly 20 and the lower vertical end 40 of the track 18. The stop member 30 may be adjustably fixed relative to the track 18 in a desired one of a plurality of positions. The stop member 30 may be a generally flat, thin linear bar including first and second ends 112, 114. In some embodiments, the stop member 30 could include one or more apertures 113 disposed between the first end 112 and the second end 114 that could receive one or more fasteners (not shown) for securing the stop member 30 relative to the track 18. The apertures may be selectively aligned with one or more corresponding holes 36 in the track 18 (as understood with reference to FIG. 5). A fastener (e.g., a screw) may extend through the holes 36 in the track 18 and may engage the window frame 12 to fix the stop member 30 relative to the track 18. Such holes 36 could receive one or more fasteners that secure the stop member 30 relative to the track 18.

Prior to securing the fastener against the stop member 30, the stop member 30 may be slid within the channel 35 of the track 18 to a desired one of a plurality of positions. Once the stop member 30 is moved to the desired position, the fastener can be tightened against the stop member 30 to secure the stop member 30 against the track 18.

The vent bar 26 may have a generally flat, elongate, linear bar-like metal body 77 extending for a length along a central longitudinal axis X3. The vent bar 26 has a first or inboard side (i.e., a side closer to the window vent 14 when the hinge assembly 16 is installed) and a second or outboard side (i.e., a side closer to the window frame 12 when the hinge assembly 16 is installed). The vent bar 26 may include an upper or first end 90 and a lower or second end 92 and a step 94 disposed proximate the first end 90. The first end 90 may include a first aperture 96 (FIG. 5) that receives a pivot pin 88 to connect the first end 90 of the vent bar 26 to the intermediate linkage assembly 25, and specifically to one end 78 of the connector link 24. The pivot pin 88 defines an axis of rotation Y1 about which the vent bar 26 and the connector link 24 may rotate or pivot relative to one another. The first end 90 of the vent bar is, therefore, pivotally connected (or coupled) to the intermediate linkage assembly 25 to allow the vent bar 26 and the connector link 24 pivot about the axis Y1. A second aperture 98 (FIG. 5) may be disposed near the second end 92 of the vent bar 26 and may also receive a pivot pin 88 to connect the second end 92 of the vent bar 26 to the intermediate linkage assembly 25, and specifically to one end 60 of the strut 22. The pivot pin 88 defines an axis of rotation Y2 about which the vent bar 26 and strut 22 may rotate or pivot relative to one another. The second end 92 of the vent bar 26 is, therefore, pivotally connected to the intermediate linkage assembly 25 to allow the vent bar 26 and the strut 22 to pivot about the axis Y2.

Additionally, the vent bar 26 may also include a plurality of slots and/or apertures 100 disposed intermediate the first and second ends 90, 92. The slot and/or apertures 100 may accommodate fasteners (e.g., screws) for fixedly securing the window sash 14 to the outboard side of the vent bar 26.

The vent bar 26 preferably may be formed from steel or another suitable metallic, polymeric or composite material.

As shown and described, the hinge assembly 16 may include an intermediate linkage assembly 25 connecting the track 18 and slider assembly 20 to the vent bar 26. The intermediate linkage assembly 25 may include the connector link 24, the brace 28, the strut 22 and, optionally, the crosslink 27. In general, each of the connector link 24, the brace 28, the strut 22 and the optional crosslink 27 may have a flat, elongate, linear bar-like body having a constant thickness and extending for a length along a central longitudinal axis from a first end to a second end. Each of the connector link 24, the brace 28, the strut 22 and the optional crosslink 27 may have a first or inboard side and a second or outboard side and each may include apertures therethrough in which pivot pins 88 may be received to pivotally connect respective components of the intermediate linkage assembly 25 to one another and to the vent bar 26, the slider assembly 20 and the track 18, as further described herein. The apertures in the linkage assembly 25 components may be generally located and centered on the respective central longitudinal axes. However, certain of the apertures (discussed herein) are laterally offset from the central longitudinal axis of some of the linkage assembly 25 components. Also, as is known, the pivot pins 88 may comprise rivets and include or incorporate bearing washer(s) and/or bushing(s) in conjunction with the fastener to facilitate the rotational or pivotal connections between the respective components of the hinge assembly 16.

The intermediate linkage assembly 25 components may preferably be formed from steel, for example. However, they may also be formed from another suitable metallic, polymeric or composite material.

The connector link 24 extends along an axis X4 from a first end 78 where it is connected to the vent bar 26 to a second end 80 where it is connected to the slider assembly 20. The first and second ends 78, 80 may include first and second apertures 82, 84 (FIG. 5), respectively. The first aperture 82 may align with the first aperture 96 of the vent bar 26. The pivot pin 88 may be received in the two apertures 82, 96 and connect the vent bar 26 and the connector link 24 and define the axis Y1 (FIG. 5) about which the first end 78 of the connector link 24 and the first end 90 of the vent bar 26 may rotate or pivot relative to one another, as already described. The second aperture 84 may receive a pivot pin 88 to connect the connector link 24 to the slider assembly 20 and define an axis of rotation Y3 (FIGS. 5, 5A) about which the second end 80 of the connector link 24 may rotate or pivot relative to first end 55, 64 of the slider assembly 20 and the track 18. In this respect, the second aperture 84 may be aligned with both of the respective first apertures 50, 71 of the shoe link 49 and the slider pad 53 and the pivot pin 88 may pass through the apertures 50, 71, 84 to join the second end 80 of the connector link 24, the first end 55 of the shoe link 49 and the first end 64 of the slider pad 53 together.

The brace 28 extends along an axis X5 from a first end 102 where it is connected to the slider assembly 20 to a second end 104 where it is connected to the strut 22. The first and second ends 102, 104 may include first and second apertures 108, 110 (FIG. X), respectively. The first aperture 108 may receive a pivot pin 88 to connect the first end of the brace 28 to the upper surface 59 of the slider assembly 20 and define an axis of rotation Y4 about which the first end 102 of the brace 28 may rotate or pivot relative to the second end 57, 65 of the slider assembly 20 and the track 18. In this respect, the first aperture 108 may be aligned with both of the respective second apertures 51, 73 of the shoe link 49 and the slider pad 53 and the pivot pin 88 may pass through the apertures 51, 73, 108 to join the first end 102 of the brace 28, the second end 57 of the shoe link 49 and the second end 65 of the slider pad 53 together. The second aperture 110 (FIGS. 5, 5A) may align with a third aperture 74 of the strut 22. A pivot pin 88 may be received in the two apertures and connect the brace 28 and the strut 22 and define an axis of rotation Y5 about which the second end 104 of the brace 28 and the strut 22 may rotate or pivot relative to one another.

The strut 22 extends along a central longitudinal axis X6 from a first end 58 where it is connected to the track 18 to a second end 60 where it is connected near the second end 92 of vent bar 26. Additionally, at a third location intermediate the first and second ends 58, 60 of the strut 22, the strut 22 is connected to a second end 104 of the brace 28 (i.e., at third aperture 74). The first end 58 may include a first aperture 62 substantially centered on the axis X6. The first aperture 62 may align with an aperture 36 at or near the second end 40 of the track. A pivot pin 88 may be received in the two apertures 62, 86 and connect the strut 22 to the track 18. The pivot pin 88 may define an axis of rotation Y6 about which the first end 58 of the strut 22 may rotate or pivot relative to the second end 40 of the track 18. The axis Y6 may be fixed relative to the track 18 during operation and motion of the hinge assembly 16 between the opened (i.e., expanded) and closed (i.e., collapsed) positions of the hinge assembly 16.

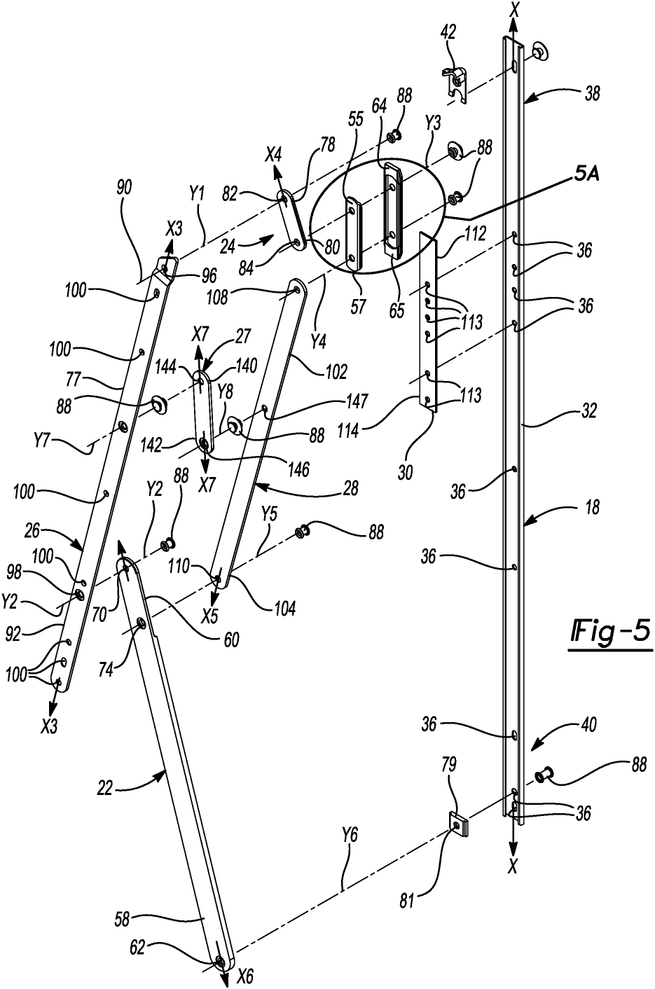

As best seen in FIG. 5, a spacer 79 is provided between the strut 22 and the track 18. The spacer 79 may be disposed in the track 18 and include an aperture 81 that is aligned with the respective apertures 62, 36 of the strut 22 and track 18. The spacer 79 may be sized in thickness such that an upper surface 85 of the spacer 79 may be substantially flush with or extend slightly beyond the inner planar boundary of the track 18. In this manner, when the strut 22 is connected to the track 18, the spacer 79 elevates the outboard side of the first end 58 of the strut 22 to be substantially coplanar with the upper surface 59, 66 of the slider assembly 20 and, hence, substantially coplanar with the second end 80 of the connector link 24 and the first end 102 the brace 28, as can be understood with reference to FIG. 4.

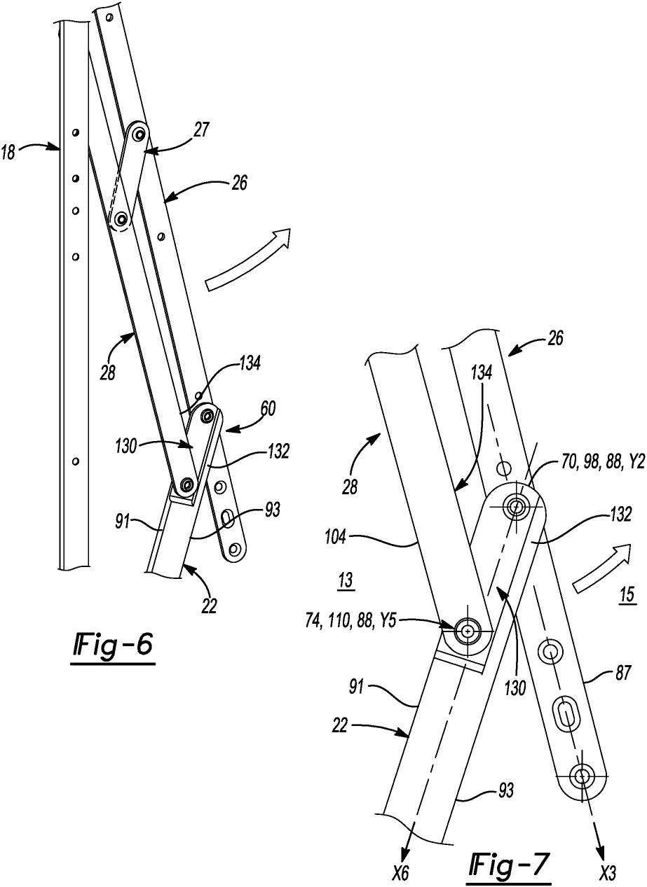

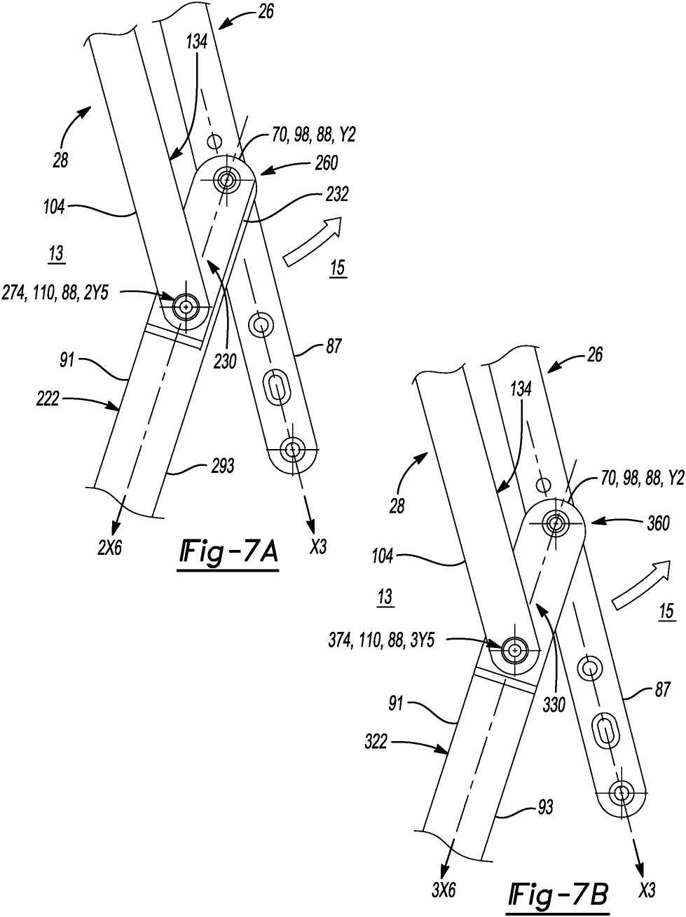

The second end 60 of the strut 22 may be pivotally connected to the second end 92 of the vent bar 26. The strut 22 and vent bar 26 are connected such that the outboard side of the strut 22 engages the inboard side of the vent bar 26. The second end 60 may include a second aperture 70 (FIG. 5). The second aperture 70 of the strut 22 may align with a second aperture 98 of the vent bar 26. A pivot pin 88 may be received in the two apertures 70, 98 and connect the strut 22 to the vent bar 26 and define an axis Y2 (FIG. 5) about which the second end 60 of the strut 22 and the second end 92 of the vent bar 26 may rotate or pivot relative to one another. Notably, however, the second aperture 98 of the vent bar 26 is laterally offset from the central longitudinal axis X3 of the vent bar 26, as best seen in FIGS. 6 and 7. Preferably, the second aperture 98 is laterally offset from the central longitudinal axis X3 toward a side edge 87 of the vent bar 26 that is closer to the exterior side 15 of the window vent 14.

As previously described, the strut 22 and the second end 104 of the brace 28 are also pivotally connected to one another at a third location of the strut 22. The strut 22 and brace 28 are connected such that the outboard side of the strut 22 engages the inboard side of the brace 28. The strut 22 may include a third aperture 74 (FIGS. 5, 6 and 7) between first end 58 and second end 60 of the strut 22. The third aperture 74 of the strut 22 may align with the second aperture 110 of the brace 28. The pivot pin 88 may be received in the two apertures 74, 110 and connect the strut 22 to the brace 28 and define the axis Y5 as previously described. The third aperture 74 of the strut 22, however, is laterally offset from the central longitudinal axis X6 of the strut 22. Preferably, the third aperture 74 is laterally offset from the central longitudinal axis X6 in a direction toward a side edge 91 of the strut 22 that is closer to the interior side 13 of the window vent 14.

It will be appreciated that the distance between the pivot axes Y2 and Y5 is slightly increased by locating the axes in the laterally offset positions described above, as compared to if the axes were located on the longitudinal centerlines of the respective links. As a result, when the hinge assembly 16 is collapsed (FIGS. 2-4), the intermediate hinge assembly 25 is slightly biased toward the opened (expanded) position. This helps to enable the hinge assembly 16 to travel smoothly between the opened (expanded) and closed (collapsed) positions while minimizing or avoiding interference or binding of the linkage components as they pivot, especially at or near the collapsed position.

With reference to FIGS. 6 and 7, the outboard side of the strut 22, at the second end 60 of the strut 22, includes a recessed portion or relief section 130. The relief section 130 may have a depth d of about half of the thickness of the strut 22. The relief section 130 may extend along the length of the strut 22 from the extreme end of the strut 22 to beyond the axis Y5. A wall 132 along the side edge 93 of the strut 22 borders one side of the relief section 132. Also shown, the second end 104 of the brace 28 is connected to the strut 22 at the relief section 130. When the hinge assembly 16 is in the closed or collapsed configuration (FIGS. 2-4), the second end 104 of the brace 28 is received within and substantially occupies the relief section 130 and a side edge portion 134 of the brace 28 lies next to or, preferably, abuts the wall 132. As such, the brace 28 and strut 22 are substantially aligned along their respective longitudinal axes X5, X6 and inhibited from deflecting or pivoting over-center relative to one another.

While the vent bar 26 and the other components of the intermediate linkage assembly 25 generally may have a uniform thickness, the strut’s 22 thickness is comparatively greater, and the strut 22 generally may have a thickness of about twice that of the other components. Accordingly, the strut 22 provides a stronger, more robust and rigid link member, improving the overall rigidity of the intermediate linkage assembly 25 and making the intermediate linkage assembly 25 less susceptible to deflection or deformation during operation as compared with prior known hinge assemblies. This, in turn, enables the hinge assembly 16 to be used with and support a wider range of sizes and weights of window vents (e.g., taller and heavier window vents) than prior known and conventional hinge assemblies. Thus, the hinge assembly of the present disclosure 16 is particularly suited for heavy-duty and commercial window applications. In particular, the hinge assembly 16 of the present disclosure can accommodate window vents more than 100 in. (2.5 m) tall and weighing more than 400 lbs. (180 kg). More specifically, the hinge assembly 16 of the present disclosure may accommodate window vents as tall as about 110 in. or more and/or weighing as much as about 450 lbs. or more.

Moreover, as shown in FIG. 3, notwithstanding that the hinge assembly 16 is suited for use with larger and/or heavier window vents, the space occupied by the hinge assembly (i.e., the “stack height (Hₛ) and the “envelope”) is not increased over conventional hinge assemblies incapable of use in heavy-duty applications. In particular, the stack height Hₛ of the hinge assembly 16 does not exceed the industry standard of 0.625 in. (16 mm). Further, the overall cross-sectional space claim or “envelope” of the hinge assembly 16 preferably does not exceed 0.625 in. x 1.015 in. (16 mm x 25.8 mm). This advantageously enables the hinge assembly 16 of the present disclosure to be used in existing standard form window frames without requiring redesigning or otherwise modifying the window frame’s standard form cross-section (e.g., the frame extrusion) to accommodate the improved hinge assembly 16.

Consequently, the hinge assembly 16 of the present disclosure can provide an increased operating capacity on the order of 150% over conventional hinge assemblies and still be sized to fit in a conventional window frame construction.

It will be appreciated that, in some embodiments, the intermediate linkage assembly 25 of the hinge assembly 16 could be configured in a variety of different ways. For example, the intermediate linkage assembly 25 may also optionally include a crosslink 27. The crosslink 27 may be employed to improve the distribution of the weight of the window vent 14 across the intermediate linkage assembly 25. The crosslink 27 may extend along an axis X7 from a first end 140 where it may be connected to the vent bar 26 (e.g., at an outboard side of the vent bar 26) to a second end 142 where it may be connected to the brace 28 (e.g.,, at an inboard side of the brace 28). The first and second ends 140, 142 may include first and second apertures 144, 146 (FIG. 5), respectively. The first aperture 144 may align with a third aperture 148 of the vent bar 26. A pivot pin 88 may be received in the two apertures 144, 148 and connect the crosslink 27 to the vent bar 26 and define an axis Y7 (FIG. 5) about which the first end 140 of the crosslink 27 and the vent bar 26 may rotate or pivot relative to one another. The second aperture 146 may align with a third aperture 147 of the brace 28. A pivot pin 88 may be received in the two apertures 146, 147 and connect the crosslink 27 to the brace 28 and define an axis of rotation Y8 (FIG. 5) about which the second end 142 of the crosslink 27 may rotate or pivot relative to the brace 28. The crosslink 27 may still further increase the overall rigidity of the intermediate linkage assembly 25 and contribute to further performance enhancements (e.g., increased operating capacities) of the hinge assembly 16.

Referring now to FIGS. 7A and 7B, further alternative constructions for the hinge assembly 16 according to the present disclosure are illustrated. Although generally similar to the arrangement shown in FIG. 7, an alternative configuration of the intermediate linkage assembly 25 can include a strut 222 as shown in FIG. 7A. Strut 222 can include a third aperture 274 that is centered on the central longitudinal axis 2X6 of the strut 222. A pivot pin 88 may be received in the aperture 274 of the strut 222 and the aperture 110 of the brace 28 to connect the brace 28 and the strut 22 and define an axis of rotation 2Y5 about which the second end 104 of the brace 28 and the strut 222 may rotate or pivot relative to one another. Thus, different from strut 22 and axis Y5 which is offset from the central longitudinal axis X6 of the strut 22, the axis of rotation 2Y5 lies on the central longitudinal axis 2X6 of the strut 222. The axis of rotation 2Y5 between the strut 222 and the brace 28 is aligned with the longitudinal axis 2X6 of the strut 222 and, as a result, the brace 28 is shifted toward the outboard side of the strut 222,

Similar to strut 22 of FIG. 7, included on the outboard side of the strut 222, at the second end 260 of the strut 222, a recessed portion or relief section 230. Again, similar to the strut 22 shown in FIG. 7, the relief section 230 may have a depth d of about half of the thickness of the strut 222 and the relief section 230 may extend along the length of the strut 222 from the extreme end of the strut 222 to beyond the axis 2Y5. Further, a wall 232 borders one side of the relief section 232 along the side edge 293 of the strut 222. When the hinge assembly 16 is in the closed or collapsed configuration (FIGS. 2-4), the second end 104 of the brace 28 is received within and substantially occupies the relief section 230 and a side edge portion 134 of the brace 28 lies next to or, preferably, abuts the wall 232. As such, the brace 28 and strut 222 are substantially aligned along their respective longitudinal axes X5, 2X6 and inhibited from deflecting or pivoting over-center relative to one another. However, because of the position of the axis of rotation 2Y5, the wall 232 is formed slightly narrower than the wall 132 of strut 22 in order to accommodate the width of the brace 28 when the hinge assembly 16 is in the closed or collapsed configuration, in the manner previously discussed in connection with FIGS. 2-4.

FIG. 7B shows still another version of a hinge assembly 16. In the embodiment of FIG. 7B, the intermediate linkage assembly 25 includes a strut 322. Like the strut 222 of FIG. 7A, the third aperture 374 of the strut 322 is centered on the central longitudinal axis 3X6 of the strut 322. And like the struts 22, 222, the strut 322 includes a recessed portion or relief section 330 at the second end 360 of the strut 322. However, unlike the struts 22, 222 shown in FIGS. 7 and 7A, strut 322 does not include a wall bordering the relief section 322 on the outboard side of the strut 322 like walls 132 and 232 previously discussed. That is, the relief section 330 of the strut 322 occupies the entirety of the second end 360 of the strut 322. When the hinge assembly 16 is closed or collapsed configuration (FIGS. 2-4), the second end 104 of the brace 28 is received within and substantially occupies the relief section 330.

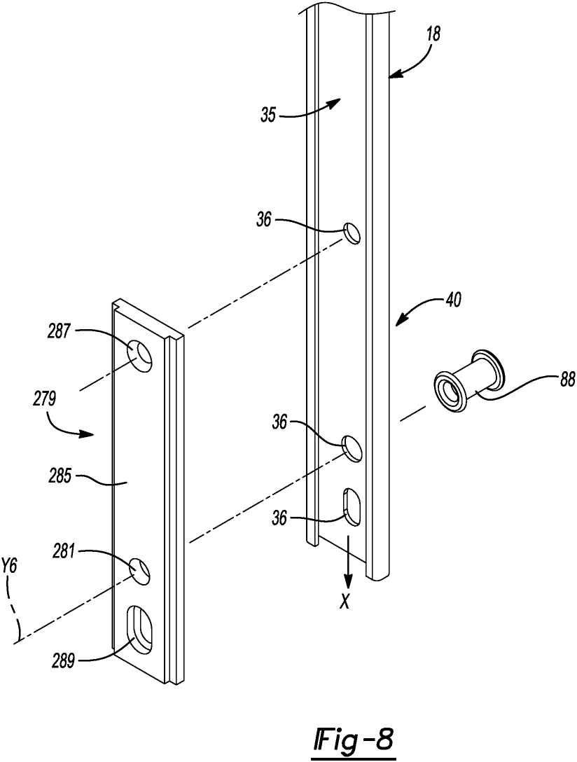

Turning now to FIG. 8, an enlarged, partial, exploded perspective view of a portion of still another alternative embodiment of the hinge assembly 16 according to the present disclosure is shown. In FIG. 8, an alternative hinge assembly 16 can include a structural spacer 279 for increasing the rigidity of the mounted hinge assembly 16 in the window frame 12. Serving in one aspect in the same manner as spacer 79 (FIG. 5 and discussion, above), the spacer 279 is located between the strut 22, 222, 322 and the track 18. The spacer 279 may be disposed within and captured by the C-shaped channel 35 of the track 18. The spacer 279 can include an aperture 281 that is aligned with the respective apertures 62, 36 of the strut 22 and track 18, respectively. As described previously, a rivet 88 joins the strut 22 to the spacer and the track 18. The rivet enables the strut 22 to pivot relative to the structural spacer 279 and the track 18 about axis Y6. The rivet 88 also fixes the structural spacer 279 to the track 18.

The spacer 279 may be sized in thickness such that an upper surface 285 of the spacer 279 may be substantially flush with or extend slightly beyond the inner planar boundary of the track 18. In this manner, when the strut 22 is connected to the the spacer 279 and the track 18, the spacer 279 elevates the outboard side of the first end 58 of the strut 22 to be substantially coplanar with the upper surface 59, 66 of the slider assembly 20 and, hence, substantially coplanar with the second end 80 of the connector link 24 and the first end 102 the brace 28, as previously described.

Additionally, the spacer 279 can be bar-like with a length and a width that are unequal (e.g., it may be a rectangular shaped bar). When the spacer 279 is disposed in the track 18, the length of the spacer 279 extends longitudinally in the track 18 along the axis X for a distance that is greater than the width of the spacer 279. Preferably, the length of the spacer 279 is substantially greater than the width of the spacer. The spacer 279 can be made from steel.

The spacer 279 further includes a second aperture 287 and a third aperture 289. The second aperture 287 and the third aperture 289 are located, respectively, near opposite longitudinal ends of the spacer 279. The apertures 287, 289 can align with corresponding apertures 36 in the track 18 to facilitate installing the hinge assembly 16. As such, when mounting the hinge assembly 16 to the window frame 12, fasteners (e.g., screws) may extend through the apertures 287, 289 of the spacer 279 and the corresponding apertures 36 of the track 18 to fixedly secure the spacer 279 and the track 18 to the window frame 12. The spacer 279 thereby serves as a rigid reinforcement within the track 18. The spacer 279 can serve to improve the overall integrity of the hinge assembly’s 16 attachment to the window frame 12 and thereby improve the hinge assembly’s 16 ability to better accommodate heavy-duty and/or commercial-grade window vents.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “connected to,” or “coupled to” another element, it may be directly connected or coupled to the other element, or intervening elements may be present. In contrast, when an element is referred to as being “directly connected to,” or “directly coupled to” another element, there may be no intervening elements present. Other words used to describe the relationship between elements should be interpreted in a like fashion (e.g., “between” versus “directly between, etc.). As used herein, the term “and/or” includes any and all combinations of one or more of the associated listed items.

Although the terms first, second, third, etc. may be used herein to describe various elements, components, regions, and/or sections, these elements, components, regions, and/or sections should not be limited by these terms. These terms may be only used to distinguish one element, component, region, or section from another region, or section. Terms such as “first,” “second,” and other numerical terms when used herein do not imply a sequence or order unless clearly indicated by the context. Thus, a first element, component, region, or section discussed below could be termed a second element, component, region, or section without departing from the teachings of the example embodiments.

Spatially relative terms, such as “inner,” “outer,” “inboard,” “outboard,” “lower,” “upper,” and the like, may be used herein for ease of description to describe one element or feature’s relationship to another element(s) or feature(s) as illustrated in the figures. Spatially relative terms may be intended to encompass different orientations of the device in use or operation in addition to the orientation depicted in the figures.

What is claimed is:

1. A high capacity, multi-bar linkage assembly for a pivotally mounted window sash, the linkage assembly movable between a closed position and an opened position, the linkage assembly comprising:
a track configured for attachment to a window frame, the track comprising a channel, a first end portion and a second end portion;
a slider assembly slidable within the channel of the track;
a vent bar having a first central longitudinal axis and extending along the first central longitudinal axis from a first end portion to a second end portion and configured for attachment to a window sash;
an intermediate linkage assembly connecting the vent bar to both the track and the slider assembly, the intermediate linkage assembly comprising a connector link, a brace and a strut, the strut having a second central longitudinal axis and extending along the second central longitudinal axis from a first end portion to a second end portion;
the connector link pivotally connected to the first end portion of the vent bar and pivotally connected to a first end portion of the slider assembly;
a first end portion of the brace pivotally connected to a second end portion of the slider assembly and a second end portion of the brace pivotally connected to the strut at a first pivotal connection that is laterally offset from the second central longitudinal axis of the strut; and
the strut further pivotally connected to the track and the vent bar, wherein the first end portion of the strut is pivotally connected to the second end portion of the track and the second end portion of the strut is pivotally connected to the vent bar at a second pivotal connection that is laterally offset from the first central longitudinal axis of the vent bar;
wherein the second end portion of the strut comprises a recess portion; and
wherein the first pivotal connection and the second pivotal connection are located in the recess portion.

2. A high capacity, multi-bar linkage assembly for a pivotally mounted window sash, the linkage assembly movable between a closed position and an opened position, the linkage assembly comprising:
a track configured for attachment to a window frame, the track comprising a channel, a first end portion and a second end portion;
a shoe having a first end portion and a second end portion and slidable along the track and within the channel, the shoe comprising a shoe link nested within a slider pad, a lower surface of the slider pad slidably engaging the channel;
a vent bar having a first central longitudinal axis and extending along the first central longitudinal axis from a first end portion to a second end portion and configured for attachment to a window sash;
an intermediate linkage assembly connecting the vent bar to both the track and the shoe, the intermediate linkage assembly comprising a first intermediate link, a second intermediate link, a third intermediate link and a fourth intermediate link, the fourth intermediate link comprising a fourth central longitudinal axis and extending from a first end portion to a second end portion;
the first intermediate link pivotally connected to the first end portion of the vent bar and pivotally connected to the first end portion of the shoe;
a first end portion of the second intermediate link pivotally connected to the second end portion of the shoe and a second end portion of the second intermediate link pivotally connected to the fourth intermediate link at a first pivotal connection that is laterally offset from the fourth central longitudinal axis, the second intermediate link further pivotally connected the third intermediate link;
the third intermediate link further pivotally connected to the vent bar; and
the fourth intermediate link further pivotally connected to the track and the vent bar, wherein the first end portion of the fourth intermediate link is pivotally connected to a second end portion of the track and a second end portion of the fourth intermediate link is pivotally connected to the vent bar at a second pivotal connection that is laterally offset from the first central longitudinal axis of the vent bar.

3. The high capacity, multi-bar linkage assembly of claim 2 wherein the second end portion of the fourth intermediate link comprises a recess portion; and
wherein the first pivotal connection and the second pivotal connection are located in the recess portion.

4. The high capacity, multi-bar linkage assembly of claim 3 wherein the fourth intermediate link comprises a bar having a first thickness and the second intermediate link comprises a bar having a second thickness, wherein the first thickness is about two times greater than the second thickness;.

5. The high capacity, multi-bar linkage assembly of claim 4 wherein the recess portion comprises a depth substantially equal to the second thickness;
wherein the recess portion comprises a surface that is bounded on at least one side by a wall extending from the surface; and
wherein the second intermediate link is configured to abut the wall when the multi-bar linkage assembly is in the closed position.

6. The high capacity, multi-bar linkage assembly of claim 3 wherein the recess portion is configured to receive the second end portion of the second intermediate link such that a surface on a first side of the second intermediate link is generally coplanar with a surface on a first side of the fourth intermediate link.

7. The high capacity, multi-bar linkage assembly of claim 2 wherein the second intermediate link is connected to the fourth intermediate link at a first side of the fourth intermediate link and the vent bar is connected to the fourth intermediate link at a second side of the fourth intermediate link opposite to the first side.

8. The high capacity, multi-bar linkage assembly of claim 1 wherein the brace is connected to the strut at a first side of the strut and the vent bar is connected to the strut at a second side of the strut opposite to the first side.

9. The high capacity, multi-bar linkage assembly of claim 2 further comprising a bar-shaped, structural spacer disposed within the channel of the track at the second end portion of the track;
wherein the first end portion of the fourth intermediate link is pivotally connected to the structural spacer and the second end portion of the track;
wherein the structural spacer comprises a first aperture and a second aperture located at opposite longitudinal ends of the structural spacer;
wherein the track further comprises a third aperture and a fourth aperture that respectively align with the first aperture and the second aperture of the structural spacer; and
wherein both the structural spacer and the track are configured for attachment to a window frame.

10. A high capacity, multi-bar linkage assembly for a pivotally mounted window sash, the linkage assembly movable between a collapsed condition and an expanded condition, the linkage assembly comprising:
a track configured for attachment to a window frame, the track comprising a channel, a first end portion and a second end portion;
a bar-shaped, structural spacer disposed within the channel of the track at the second end portion of the track;
a slider assembly slidable within the channel of the track;
a vent bar having a central longitudinal axis and extending from a first end portion to a second end portion and configured for attachment to a window sash;
an intermediate linkage assembly connecting the vent bar to both the track and the slider assembly, the intermediate linkage assembly comprising a connector link, a brace and a strut a having a central longitudinal axis and extending along from a first end portion to a second end portion;
the connector link pivotally connected to the first end portion of the vent bar and pivotally connected to a first end portion of the slider assembly;
a first end portion of the brace pivotally connected to a second end portion of the slider assembly and a second end portion of the brace pivotally connected to the strut at a first pivotal connection; and
the strut further pivotally connected to the track, the structural spacer and the vent bar, wherein the first end portion of the strut is pivotally connected to the structural spacer and the second end portion of the track and the second end portion of the strut is pivotally connected to the vent bar at a second pivotal connection;
wherein the second end portion of the strut comprises a recess portion;
wherein the first pivotal connection and the second pivotal connection are located in the recess portion and
wherein the second pivotal connection is laterally offset from the central longitudinal axis of the vent bar.

11. (canceled)

12. The high capacity, multi-bar linkage assembly of claim 10 or 11 wherein the strut comprises a bar having a first thickness and the brace comprises a bar having a second thickness, wherein the first thickness is about two times greater than the second thickness;.

13. The high capacity, multi-bar linkage assembly of claim 10 wherein the recess portion comprises a depth substantially equal to the second thickness of the brace;
wherein the recess portion comprises a surface that is bounded on at least one side by a side wall extending from the surface; and
wherein the brace is configured to abut the wall when the high capacity, multi-bar linkage assembly is in the collapsed condition.

14. The high capacity, multi-bar linkage assembly of claim 10 wherein the structural spacer comprises a first aperture and a second aperture located at opposite longitudinal ends of the structural spacer;
wherein the track further comprises a third aperture and a fourth aperture that respectively align with the first aperture and the second aperture of the structural spacer; and
wherein both the structural spacer and the track are configured for attachment to a window frame.

15. The high capacity, multi-bar linkage assembly of claim 1 wherein the strut comprises a bar having a first thickness and the brace comprises a bar having a second thickness, wherein the first thickness is about two times greater than the second thickness.

16. The high capacity, multi-bar linkage assembly of claim 1 wherein the recess portion comprises a depth substantially equal to the second thickness;
wherein the recess portion comprises a surface that is bounded on at least one side by a wall extending from the surface; and
wherein the brace is configured to abut the wall when the multi-bar linkage assembly is in the closed position.

17. The high capacity, multi-bar linkage assembly of claim 1 wherein the recess portion is configured to receive the second end portion of the brace such that a surface on a first side of the brace is generally coplanar with a surface on a first side of the strut.

18. The high capacity, multi-bar linkage assembly of claim 1 further comprising a bar-shaped, structural spacer disposed within the channel of the track at the second end portion of the track;
wherein the first end portion of the strut is pivotally connected to the structural spacer and the second end portion of the track;
wherein the structural spacer comprises a first aperture and a second aperture located at opposite longitudinal ends of the structural spacer;
wherein the track further comprises a third aperture and a fourth aperture that respectively align with the first aperture and the second aperture of the structural spacer; and
wherein both the structural spacer and the track are configured for attachment to a window frame.
